(19) United States
(12) Patent Application Publication
(10) Pub. No.: US 2009/0299953 A1
(43) Pub. Date: Dec. 3, 2009

(54) MERCHANDISER WITH AUTOMATED REPORT GENERATION SYSTEM

(76) Inventor: Ted Wayne Sunderland, Troy, MI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/131,689

(22) Filed: Jun. 2, 2008

(51) Int. Cl. G06F 17/30

(52) U.S. Cl. 707/1; 707/104.1; 707/E17.001; 707/E17.044

(57) ABSTRACT

A method of operating a report generation system for a merchandiser including a case defining a product display area, and a refrigeration system operable to condition the product display area. The method comprises sensing at least one condition of the merchandiser using a sensing device, generating a signal indicative of the merchandiser condition, retrieving the signal indicative of the merchandiser condition using a controller, and automatically generating a data report including the signal indicative of the merchandiser condition using a report generation device

### BACKGROUND

The present invention relates to a report generation system for a merchandiser that supports product in a conditioned space. More particularly, the present invention relates to a report generation system for a merchandiser that generates and distributes data reports related to data retrieved from the merchandiser.

Generally, merchandisers include a product display area that supports product. Often, the temperature of the product display area is recorded manually and periodically by an operator to monitor operation of refrigeration system components. Typically, the product display area temperature is recorded by the operator based on a predetermined schedule.

### SUMMARY

In one embodiment, the invention provides a method of operating a report generation system for a merchandiser including a case defining a product display area, and a refrigeration system operable to condition the product display area. The method includes sensing at least one condition of the merchandiser using a sensing device, generating a signal indicative of the merchandiser condition, retrieving the signal indicative of the merchandiser condition using a controller, and automatically generating a data report including the signal indicative of the merchandiser condition using a report generation device.

In another embodiment, the invention provides a method of operating a report generation system for a merchandiser including a case defining a product display area, a refrigeration system operable to condition the product display area, and a sensing device in communication with the merchandiser. The method includes sensing at least one condition of the merchandiser using a sensing device, generating a signal indicative of the merchandiser condition, generating a data report including the signal indicative of the merchandiser condition, and generating a delivery condition associated with the delivery of the data report to an end destination. The method further includes retrieving the delivery condition from the end destination, and automatically generating a delivery report including the delivery condition.

In another construction, the invention provides a report generation system for a merchandiser including a case defining a product display area, a sensing device in communication with the merchandiser, and a refrigeration system operable to condition the product display area. The report generation includes a controller in communication with the sensing device to retrieve at least one signal that is sensed and generated by the sensing device, the signal indicative of a condition of the merchandiser, and a report generation device in communication with the controller, and programmed to automatically retrieve the signal indicative of the merchandiser condition and to automatically generate a data report having the signal indicative of the merchandiser condition.

Other aspects of the invention will become apparent by consideration of the detailed description and accompanying drawings.

### BRIEF DESCRIPTION OF THE DRAWINGS

FIG. 1 is a perspective view of a merchandiser embodying the invention.

FIG. 2 is a schematic view of the merchandiser and a report generation system that is coupled to the merchandiser.

FIG. 3 is a schematic view of an exemplary data report generated by the report generation system of FIG. 2.

FIG. 4 is a schematic view of an exemplary delivery report of the report generation system of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

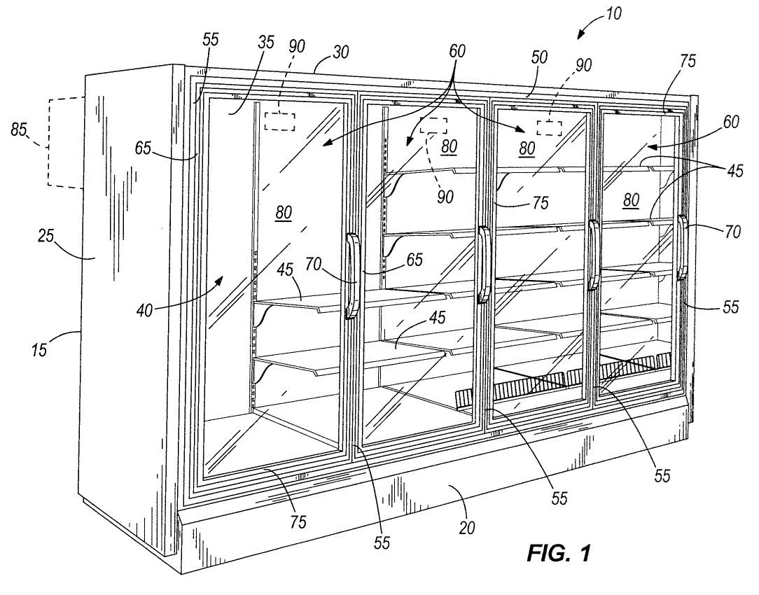

FIG. 1 shows a merchandiser 10 for displaying product (e.g., frozen food, fresh food, beverages, etc.) available to consumers in a retail setting (e.g., a supermarket or grocery store, etc.). The refrigerated merchandiser 10 includes a case 15 that has a base 20, side walls 25, a case top or canopy 30, and a rear wall 35. The base 20, the side walls 25, the case top 30, and the rear wall 35 cooperate to define a product display area 40. The product is supported on shelves 45 within the product display area 40.

FIG. 1 shows that the case 15 includes a casing 50 adjacent a front of the merchandiser 10. The casing 50 includes vertical mullions 55 that define openings 60, and doors 65 positioned over the openings 60. The openings 60 and the doors 65 allow access to product stored in the product display area 40. The mullions 55 are spaced horizontally along the case 15 to provide structural support for the case 15. Each mullion 55 is defined by a structural member that can be formed from a non-metallic or metallic material. A handle 70 is positioned along an edge of each door 65 to move the door 65 between an open position and a closed position.

Each door 65 includes a frame 75 that attaches a translucent member 80 to the door 65 to allow viewing of the product from outside the case 15. The translucent member 80 can be formed from glass, or alternatively, from other materials that are substantially translucent (e.g., acrylic, etc.). In some constructions, the case 15 can include doors 65 without attachment of the doors 65 to mullions 55. In still other constructions, the case 15 can be an open-front case without the mullions 55 and doors 65, or any other refrigerated case used to display perishable food product.

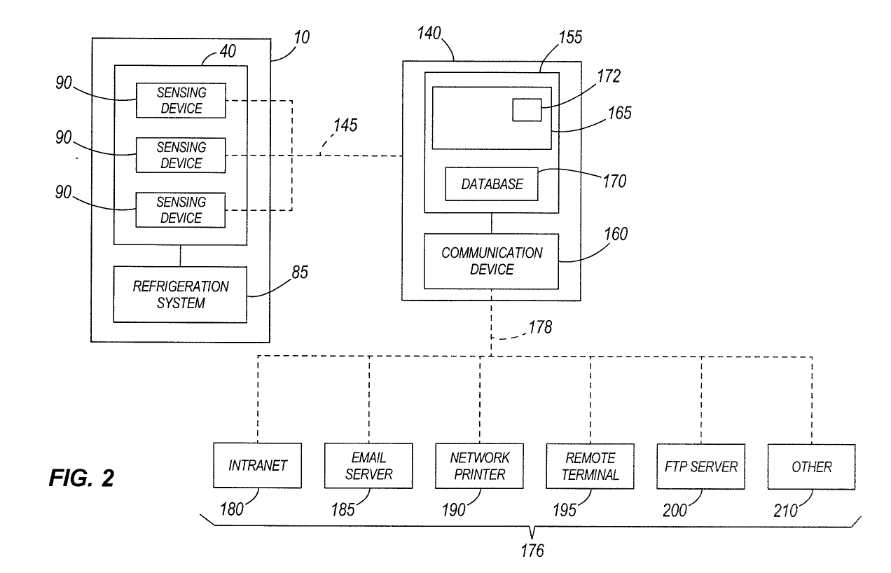

With further reference to FIG. 2, the merchandiser 10 also includes a refrigeration system 85, and sensing devices 90. The refrigeration system 85 is coupled to the case 15 to refrigerate the product display area 40. In some constructions, at least a portion of the refrigeration system 85 may be located outside or away from the case 15. In other constructions, the merchandiser 10 may include an air circulation system or a heating system to heat the product display area 40. In still other constructions, the merchandiser 10 may include more than one conditioning system. The conditioning systems (e.g. the refrigeration system 85, the air circulation system, etc.) discussed herein are only exemplary, and other conditioning systems are possible and considered herein.

The sensing devices 90 are in communication with the merchandiser 10 to sense conditions of the merchandiser 10, and to generate a signal that is indicative of the associated merchandiser condition. In some constructions, one or more of the sensing devices 90 can be positioned in or adjacent to the product display area 40 to sense one or more conditions of the case 15 (e.g., temperature, humidity, pressure, case status, lighting characteristics, shelf weight, etc.). In other constructions, one or more of the sensing devices 90 can be located on the merchandiser to sense one or more conditions of the refrigeration system 85 (e.g., refrigerant capacity, refrigerant temperature, refrigerant pressure, operational characteristics of components of the refrigeration system, etc.). In still other constructions, the sensing devices 90 can be used to sense other conditions of the merchandiser 10. Hereinafter, the term “merchandiser condition” shall be used to represent all conditions of the merchandiser 10 that can be sensed by the sensing devices 90, including but not limited to conditions of the case 15 and conditions of the refrigeration system 85. In the illustrated construction, the merchandiser 10 includes three sensing devices 90 that are coupled to the case 15 within the product display area 40. In other constructions, the merchandiser 10 may include more or fewer than three sensing devices 90.

FIG. 2 shows a report generation system 140 that is in communication with the sensing devices 90 via a first communication link 145. In some constructions, the report generation system 140 is in wireless communication with the sensing devices 90. In other constructions, the report generation system 140 can be in wired communication with the sensing devices 90. In still other constructions, the report generation system 140 can be in communication with the sensing devices 90 using a combination of wired and wireless connections.

In some constructions, the report generation system 140 is in communication with the case 15 and the product display area 40 of a single merchandiser 10. In other constructions, the report generation system 140 can be in communication with a plurality of cases 15 and a plurality of product display areas 40 of one or more merchandisers 10 (e.g., a merchandiser 10 that includes two or more cases 15 and/or product display areas 40, or two or more merchandisers 10 that include one or more cases and/or product display areas 40, etc.). The report generation system 140 can be located remotely from the merchandiser 10, or alternatively, the report generation system 140 can be coupled to the merchandiser 10. For example, the report generation system 140 may be located directly on the case 15.

FIG. 2 shows that the report generation system 140 includes a processing system 155 and a communication device 160 for communicating information to and from the processing system 155. The processing system 155 includes a controller 165, a database 170, and a report generation device 172. The controller 165 is in communication with the sensing devices 90 via the first communication link 145 to automatically retrieve the signals indicative of the merchandiser conditions from the sensing devices 90. The controller 165 also is in communication with the database 170 to automatically deliver the retrieved signals indicative of the merchandiser conditions to the database 170. In some constructions, the controller 165 can be programmed to retrieve the signals from the sensing devices 90 at predetermined intervals. In other constructions, the controller 165 may continuously retrieve the signals from the sensing devices 90. In other constructions, the controller 165 generates data indicative of identifying information (e.g., the date, the time, the location, etc.) of the signal when retrieved, and stores the data and signal in the database 170.

As illustrated in FIG. 2, the database 170 is integrated with or subsumed in the processing system 155. In other constructions, the database 170 may be separate from the processing system 155. The database 170 stores the signals and data until called upon for delivery. In some constructions, the database 170 also stores data entered by an end user or operator as user-defined data. In some constructions, the database 170 can be in wireless communication with the controller 165. In other constructions, the database 170 can be in wired communication with the controller 165. In still other constructions, the database 170 may be in communication with the controller 165 using a combination of a wireless and wired connection.

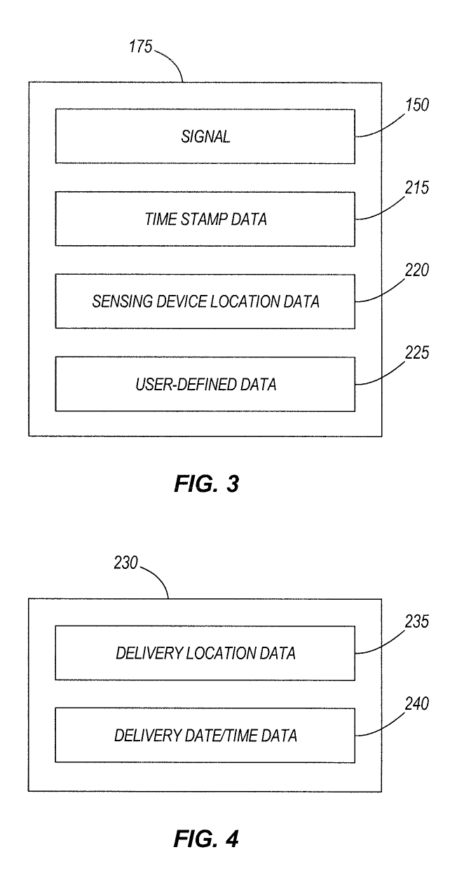

As illustrated in FIG. 2, the report generation device 172 is in communication with the controller 165 and is subsumed in the controller 165. In other constructions, the report generation device 172 can be external of the controller 165. The report generation device 172 is in communication with the database 170 to retrieve the signals and data stored in the database 170. The report generation device 172 also generates a data report (an exemplary data report 175 is shown in FIG. 3) that includes the signals 150 indicative of the merchandiser conditions, and the data indicative of identifying information of the signals 150. In some constructions, the report generation device 172 automatically retrieves the signals and data, and automatically generates the data report 175 based on a predetermined interval. In other constructions, the predetermined interval can be varied by the end user. The report generation device 172 also is in communication with the communication device 160 to deliver the data report 175 to an end destination 176. In some constructions, the report generation device 172 automatically delivers the data report 175 to the end destination 176.

In other constructions, the report generation device 172 retrieves the signals from the sensing devices 90 and generates a data report 175 without storing the signals in the database 170 prior to generating the data report 175. For example, the report generation device 172 retrieves the signals from the sensing devices 90, generates data indicative of identifying information of the signals similar to data generated by the controller, and generates a data report 175 that includes the retrieved signals and generated data.

Generally, the communication device 160 is capable of sending information between the processing system 155 and the end destination 176 at predetermined intervals, which can be programmed by the end user. The end destination 176 can be located anywhere relative to the merchandiser 10 (e.g., adjacent the merchandiser 10, remotely located from the merchandiser 10, etc.). As illustrated in FIG. 2, the end destination 176 can include one or more of an intranet 180, an email server 185, a network printer 190, a remote terminal 195, and a FTP (file transfer protocol) server 200. In some constructions, the communication device 160 also may be in communication with other end destinations.

The communication device 160 is in communication with each end destination 176 via a second communication link 178. In some constructions, the second communication link 178 between the communication device 160 and each end destination is a wired connection. In other constructions, the second communication link 178 can be a wireless connection. In still other constructions, the second communication link 178 can be a combination of a wireless and wired connection. Furthermore, the second communication link 178 can be a one-way or two-way communication link between the communication device 160 and each end destination 176. For example, in constructions of the report generation system 140 that include a one-way communication link between the communication device 160 and the end destinations 176, the second communication link 178 can deliver data from the communication device 160 to the end destinations 176. In constructions of the report generation system 140 that include a two-way communication link, the second communication link 178 can deliver information between the communication device 160 and the end destinations 176.

The report generation system 140 can automatically generate a plurality of data reports 175 simultaneously or sequentially. Each automatically-generated data report 175 is stored in the database 170. Generally, the data reports 175 can have any format and include a variety of information related to the signal 150 indicative of the merchandiser condition that is retrieved by the controller 165. The data report 175 is stored in the database 170. The data report 175 can also be delivered to the appropriate end destination 176 concurrent with storage of the data report 175 in the database 170, or some later predetermined time. In some constructions, the report generation system 140 can generate one or more data reports that include signals 150 related to one particular merchandiser condition. For example, the report generation system 140 may generate two data reports (e.g., a morning data report and an afternoon data report) that each has a plurality of signals 150 relating to the temperature (e.g., one merchandiser condition) of the product display area 40 during two particular time cycles (e.g., the morning and the afternoon).

In other constructions, the report generation system 140 can automatically generate a plurality of data reports such that each data report includes signals 150 related to a different, particular merchandiser condition. For example, one data report may include signals 150 related to temperature and another data report may include signals 150 related to lighting characteristics.

In still other constructions, the report generation system 140 can generate one or more data reports such that each data report includes signals related to a plurality of merchandiser conditions. For example, a single data report may include signals related to temperature, humidity, pressure, and shelf weight.

FIG. 3 shows an exemplary data report 175 that is automatically generated by the report generation system 140 and automatically stored in the database 170. As illustrated in FIG. 3, the data report 175 includes signals 150 indicative of the merchandiser conditions, time stamp data 215 and sensing device location data 220. The signals 150 are compiled by the sensing devices 90, and are indicative of the sensed merchandiser conditions (e.g., temperature, humidity, case status, etc.). The time stamp data 215 and sensing device location data 220 are compiled by either of the controller 165 or the report generation device 172, and are indicative of the identifying information of the signals (e.g., the date, the time, the location, etc.). Specifically, the time stamp data 215 is indicative of the time at which the signal is retrieved from the sensing device 90 and recorded by the controller 165, and the sensor location data 220 is indicative of the location or position of each sensing device 90 within the merchandiser 10 from which the signal is retrieved. The data report 175 also includes user-defined data 225 that is compiled by the operator, and indicative of information the operator desires to contribute to the data report. For example, the user-defined data 225 may include information related to the type of product in the product display area 40 and retailer information (e.g., the name of the retail company). In other constructions, the data report 175 can include other data and information related to the merchandiser 10, required temperature, parameters, or product information.

The report generation system 140 also automatically generates delivery reports 230. Each delivery report 230 includes delivery data that is generated by the controller 165 and that is retrieved from the end destination 172. In some constructions, the delivery data is generated by the report generation device 172. Generally, the delivery data is related to generation and delivery of the data report 175. Examples of generated delivery data include the date and time that the data report 175 is generated, the date and time that the data report 175 is delivered to each end destination 176, and the identification of the end destination 176 to which the data report 175 has been delivered. Examples of retrieved delivery data include delivery conditions received from the end destination 176 via the communication device 160 and related to the delivery status of the data report (e.g., delivered, pending, canceled, in route, etc.). The delivery report can also include other data and conditions related to the delivery and/or storage of the data report 175 not discussed herein. The delivery report 230 is generated by the report generation device 172, and includes the delivery data generated by either the controller 165 or the report generation device 172 and the delivery conditions retrieved from the end destination 176.

FIG. 4 shows an exemplary delivery report 230 that is generated by the report generation system 140. The illustrated delivery report 230 includes delivery location data 235 related to the end destination 176 to which the data report 175 has been delivered, and delivery date/time data 240 associated with the date and time of the delivery of the data report 175.

Generally, the report generation system 140 automatically generates the delivery report 230 for each data report 175 that is delivered to an end destination 176. In some constructions, the report generation system 140 can generate the delivery report 230 in response to instructions from the operator. In still other constructions, one delivery report 230 can be automatically generated by the report generation system 140 for a plurality of data reports 175. The communication device 160 is in communication with the end destinations 176 to communicate the delivery report 230 from the end destinations 176 to the database 170 so that the delivery report 230 can be stored for access by an authorized operator,

In operation, each sensing device 90 senses a condition (e.g., temperature) of the case 15 and/or the product display area 40, and generates a signal 150 that is indicative of the merchandiser condition. As discussed above, the signal 150 indicative of the merchandiser condition is compiled or retrieved by the controller 165. The controller 165 retrieves the signal 150 via the first communication link 145, and stores the signal 150 in the database 170. In some constructions, the controller 165 can automatically generate the data report 175 using the report generation device 172 when the signal 150 is retrieved. In other constructions, the controller 165 can automatically generate the data report 175 using the report generation device 172 after the case data 150 is stored in the database 170. Generally, the controller 165, using the report generation device 172, automatically generates and formats the data report 175 to include the signals and data that is to be delivered to the end destination 176 via the communication device 160 and the second communication link 178.

In some constructions, the controller 165 generates the data report 175 based on predetermined intervals that are programmed into the processing system 155. In other constructions, the report generation device 172 can automatically generate the data report 175 based on inputs or commands from an operator. In still other constructions, the report generation device 172 may generate the data report 175 as soon as the signal 150, and other data, is retrieved and compiled. After the data report 175 is generated, the data report 175 can be stored in the database 170, or alternatively, sent to one or more end destinations 176 via the communication device 160 and the second communication link 178.

The controller 165 delivers the data report 175 to the end destination 176 using the communication device 160. Generally, the communication device 160 delivers a plurality of data reports 175 to the predetermined end destination(s) 176 at the same time. In other constructions, the communication device 160 can deliver one data report 175 at a time to the predetermined end destination(s) 176. In still other constructions, the communication device 160 can deliver data reports 175 at spaced apart or predetermined intervals that are programmed into the processing system 155.

Delivery conditions (e.g., delivery status of data report, identification of the end destinations 176, etc.) are communicated from the end destination 176 to the database 170 via the communication device 160 and the second communication link 178. Upon receipt of the delivery conditions and generation of the delivery report 230, the report generation system 140 automatically generates and formats a report profile. The report profile includes the data report 175 and the associated delivery report 230, and is stored in the database 170 for archival of the reports 175, 230. The report profile, including the data report 175 and the delivery report 230, can be retrieved from the database 170 automatically or manually by an authorized operator.

In other constructions, the controller 165 or the report generation device 172 can convert the signal into a particular format to store in the database 170 and to include in the data report 175.

Various features and advantages of the invention are set forth in the following claims.

What is claimed is:

1. A method of operating a report generation system for a merchandiser including a case defining a product display area, and a refrigeration system operable to condition the product display area, the method comprising:
sensing at least one condition of the merchandiser using a sensing device;
generating a signal indicative of the merchandiser condition;
retrieving the signal indicative of the merchandiser condition using a controller; and
automatically generating a data report including the signal indicative of the merchandiser condition using a report generation device.

2. The method of claim 1, further comprising retrieving the signal indicative of the merchandiser condition from the sensing device at a predetermined interval.

3. The method of claim 1, further comprising communicating wirelessly between the report generation system and the sensing device.

4. The method of claim 1, further comprising
generating time stamp data indicative of the time at which the signal indicative of the merchandiser condition is retrieved;
generating location data indicative of the location of the sensing device when the signal indicative of the merchandiser condition is retrieved; and
formatting the data report to include the time stamp data and the location data.

5. The method of claim 1, further comprising
storing the signals indicative of the merchandiser condition in a database; and
automatically retrieving the stored signal indicative of the merchandiser condition from the database.

6. The method of claim 5, further comprising retrieving the stored signal indicative of the merchandiser condition from the database at a predetermined interval.

7. The method of claim 5, further comprising storing the data report in the database.

8. The method of claim 1, further comprising distributing the data report to an end destination.

9. The method of claim 8, further comprising communicating the data report wirelessly to the end destination using a communication device of the report generation system.

10. The method of claim 8, further comprising distributing the data report to the end destination at a predetermined interval.

11. The method of claim 8, further comprising
generating a delivery condition associated with the delivery of the data report to the end destination;
retrieving the delivery condition from the end destination;
automatically generating a delivery report including the delivery condition using the report generation device; and
storing the delivery report in a database.

12. The method of claim 11, further comprising
generating delivery data related to the generation and the delivery of the data report using the controller; and
formatting the delivery report to further include the delivery data.

13. A method of operating a report generation system for a merchandiser including a case defining a product display area, a refrigeration system operable to condition the product display area, and a sensing device in communication with the merchandiser, the method comprising:
sensing at least one condition of the merchandiser using a sensing device;
generating a signal indicative of the merchandiser condition;
generating a data report including the signal indicative of the merchandiser condition;
generating a delivery condition associated with the delivery of the data report to an end destination;
retrieving the delivery condition from the end destination; and
automatically generating a delivery report including the delivery condition.

14. The method of claim 13, further comprising
generating delivery data related to the generation and the delivery of the data report to the end destination; and
formatting the delivery report to further include the delivery data.

15. The method of claim 14, further comprising retrieving the delivery conditions and generating the delivery data at a predetermined interval.

16. The method of claim 13, further comprising generating the delivery report at a predetermined interval.

17. The method of claim 13, further comprising storing the delivery report in a database.

18. The method of claim 13, further comprising
automatically generating a report profile including the data report and the delivery report; and
storing the report profile in a database.

19. A report generation system for a merchandiser including a case defining a product display area, a sensing device in communication with the merchandiser, and a refrigeration system operable to condition the product display area, the report generation system comprising:
a controller in communication with the sensing device to retrieve at least one signal that is sensed and generated by the sensing device, the signal indicative of a condition of the merchandiser; and
a report generation device in communication with the controller, and programmed to automatically retrieve the signal indicative of the merchandiser condition and to automatically generate a data report having the signal indicative of the merchandiser condition.

20. The report generation system of claim 19, further comprising a database, wherein the controller is in communication with the database to store and retrieve the signal indicative of the merchandiser condition.

21. The report generation system of claim 20, wherein the controller is in wireless communication with the sensing device and the database.

22. The report generation system of claim 19, wherein the controller is programmed to retrieve the signal indicative of the merchandiser condition at a predetermined interval.

23. The report generation system of claim 19, wherein the report generation device is operable to generate the data report at a predetermined interval.

24. The report generation system of claim 19, wherein the data report includes time stamp data that is indicative of the time at which the signal indicative of the merchandiser condition is retrieved.

25. The report generation system of claim 19, wherein the data report includes location data that is indicative of the location of the sensing device within the merchandiser from which the signal indicative of the merchandiser condition is retrieved.

26. The report generation system of claim 19, further comprising a communication device that is in communication with the report generation device and an end destination, wherein the controller is programmed to distribute the data report to the end destination via the communication device at a predetermined interval.

27. The report generation system of claim 26, wherein the controller is programmed to communicate a delivery report from the end destination to a database, the delivery report including delivery data that is indicative of at least one condition of the delivery of the data report to the end destination.

28. The report generation system of claim 27, further comprising a report profile including the data report and delivery report, wherein the controller is programmed to store the report profile in the database.
